(19) United States
(12) Patent Application Publication
(10) Pub. No.: US 2011/0183251 A1
(43) Pub. Date: Jul. 28, 2011

(54) DEVELOPING AGENT AND METHOD FOR MANUFACTURING THE SAME

(75) Inventor: Tsutomu Katsumata, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/005,922

(22) Filed: Jan. 13, 2011

Related U.S. Application Data
(60) Provisional application No. 61/299,098, filed on Jan. 28, 2010.

(51) Int. Cl. G03G 9/097

(52) U.S. Cl. 430/108.23; 430/108.4; 430/137.1; 430/137.18

(57) ABSTRACT

According to one embodiment, there is provided a developing agent including a toner particle containing a coloring agent, a binder resin and an ester wax having an alkyl group having a carbon number of from 32 to 46. When the wax is analyzed by an mass spectrometry, an ester compound having a carbon number showing the maximum strength ratio accounts for from 20 to 45% by mass of the whole of the wax.

### CROSS-REFERENCE TO RELATED APPLICATIONS

This application is based upon and claims the benefit of priority from U.S. Provisional Application No. 61/299,098, filed Jan. 28, 2010, the entire contents of which are incorporated herein by reference.

### FIELD

Embodiments described herein relate generally to a developing agent for developing an electrostatic charge image or a magnetic latent image in an electrophotography method, an electrostatic printing method, a magnetic recording method and the like, and to a method for manufacturing the same.

### BACKGROUND

An ester wax is hardly finely dispersed in a toner, and a dispersed size of the wax in the toner tends to become large. Therefore, there is involved such a problem that the ester wax is not excellent in low-temperature offset resistance. Furthermore, when this ester wax is used, the amount of a wax deposited on the toner surface is easy to increase, the tribo charge in a high-temperature high-humidity environment is lowered, and as the life proceeds, toner dusting tends to be deteriorated. For that reason, when the ester wax is used, there are limits in lower temperature fusings, flow rate and life extension.

### BRIEF DESCRIPTION OF THE DRAWINGS

FIG. 1 is an exemplary view showing a flow expressing an example of a manufacturing method of a developing agent according to an embodiment.

FIG. 2 is an exemplary view showing an image forming apparatus according to an embodiment.

### DETAILED DESCRIPTION

In general, according to one embodiment, there is provided a developing agent including a toner particle containing a coloring agent, a binder resin and an ester wax having an alkyl group having a carbon number of from 32 to 46, wherein when the wax is analyzed by an mass spectrometry, an ester compound having a carbon number showing the maximum strength ratio accounts for from 20 to 45% by mass of the whole of the wax.

Also, according another embodiment, there is provided a method for manufacturing a developing agent which is an example of a method for manufacturing the foregoing developing agent, including

undergoing an esterification reaction using a carboxylic acid component having a carbon number of from 16 to 24 and an alcohol component having a carbon number of from 16 to 22 to form an ester wax which is an ester wax having an alkyl group having a carbon number of from 32 to 46 and in which an ester wax having an alkyl group having one carbon number of the carbon number of from 32 to 46 accounts for from 20 to 45% by mass of the mass of the whole of the ester waxes; and

forming a toner particle using a toner particle material containing the ester wax, a binder resin and a coloring agent.

The formation of the toner particle can be, for example, carried out by

melt kneading the toner particle material to form a kneaded material;

pulverizing the kneaded material to form a coarsely granulated mixture;

mixing the coarsely granulated mixture with an aqueous medium to prepare a dispersion;

providing the dispersion for mechanical shearing to form a fine particle of the coarsely granulated mixture; and

coagulating the fine particle in the dispersion.

According to the embodiment, all of three characteristics of lower temperature fusing, flow rate and life extension can be made compatible with each other by using an ester wax having an alkyl group with a relatively short straight chain.

Lower temperature fusing and lowering Tg of the toner are correlated with each other. A method of lowering Tg of the toner includes two kinds of a method in which Tg of the resin is decreased, thereby achieving lowering Tg of the toner; and a method in which a wax with good dispersibility is added, thereby achieving lowering Tg of the toner. However, the lower temperature fusing and the flow rate are in a trade-off relation, and when the toner is subjected to lowering Tg, the flow rate is deteriorated. Thus, it is difficult to satisfy the both characteristics. On the other hand, according to the embodiment, by using the ester wax having an alkyl group with a short straight chain to achieve lowering Tg of the toner rather than undergoing lowering Tg of the resin, the lower temperature fusing and the flow rate can be made well compatible with each other. Also, since the ester wax having the foregoing characteristic features has good dispersibility, the amount of a wax deposited on the toner surface is small, a lowering of the tribo charge in a high-temperature high-humidity environment can be reduced, and the life extension can be realized.

As raw material monomers of the polyester resin which are used in the embodiment, for example, a dihydric or polyhydric alcohol component and a divalent or polyvalent carboxylic acid component such as carboxylic acids, carboxylic acid anhydrides and carboxylic acid esters are used.

Examples of the dihydric alcohol component include alkylene oxide adducts of bisphenol A such as polyoxypropylene(2.2)-2,2-bis(4-hydroxyphenyl)propane, polyoxypropylene(3.3)-2,2-bis(4-hydroxyphenyl)propane, polyoxyethylene(2.0)-2,2-bis(4-hydroxyphenyl)propane, polyoxypropylene(2.0)-polyoxyethylene(2.0)-2,2-bis(4-hydroxyphenyl)propane and polyoxypropylene(6)-2,2-bis(4-hydroxyphenyl)propane, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A and hydrogenated bisphenol A.

The dihydric alcohol component can be selected from bisphenol A-alkylene (carbon number: 2 or 3) oxide adducts (average addition molar number: 1 to 10), ethylene glycol, propylene glycol, 1,6-hexanediol, bisphenol A, hydrogenated bisphenol A and the like.

Examples of the trihydric or polyhydric alcohol component can include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane and 1,3,5-trihydroxymethylbenzene.

The trihydric or polyhydric alcohol component can be selected from sorbitol, 1,4-sorbitan, pentaerythritol, glycerol, trimethylolpropane and the like.

In the embodiment, these dihydric alcohols and trihydric or polyhydric alcohols can be used singly or in combinations of plural kinds thereof. For example, a bisphenol A-alkylene (carbon number: 2 or 3) oxide adduct (average addition molar number: 1 to 10) can be used as a main component.

Examples of the divalent carboxylic acid component include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, alkenyl succinates such as n-dodecenyl succinate, alkyl succinates such as n-dodecyl succinate, and anhydrides or lower alkyl esters of these acids.

The divalent carboxylic acid component can be selected from maleic acid, fumaric acid, terephthalic acid, and a succinic acid substituted with an alkenyl group having a carbon number of from 2 to 20.

Examples of the trivalent or polyvalent carboxylic acid component can include 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, empole trimer acid, and anhydrides or lower alkyl esters of these acids.

The trivalent or polyvalent carboxylic acid component is selected from 1,2,4-benzenetricarboyxlic acid (trimellitic acid), an acid anhydride or alkyl (carbon number: 1 to 12) ester thereof, and the like.

In the embodiment, these divalent carboxylic acids and trivalent or polyvalent carboxylic acids can be used singly or in combinations of plural kinds thereof. It can use, as a main component, fumaric acid, terephthalic acid or a succinic acid substituted with an alkenyl group having a carbon number of from 2 to 20, which is a divalent carboxylic acid component, or 1,2,4-benzenetricarboyxlic acid (trimellitic acid) or an acid anhydride or alkyl (carbon number: 1 to 12) ester thereof, which is a trivalent or polyvalent carboxylic acid component.

In polymerizing the raw material monomers of the polyester, in order to promote the reaction, a catalyst which is usually used, such as dibutyltin oxide, a titanium compound, a dialkoxytin(II), tin(II) oxide, a fatty acid tin(II), tin(II) dioctanoate and tin(II) distearate, may be properly used.

As the wax which is used in the embodiment, a wax synthesized from a long-chain alkyl carboxylic acid component and a long-chain alkyl alcohol component is used. Though the addition amount of the wax is not particularly limited, it is preferable from 3 to 10 parts by weight based on 100 parts by weight of the binder resin.

As the coloring agent, carbon black or organic or inorganic pigments or dyes which are used in the color toner application can be used. In the embodiment, examples of the carbon black include acetylene black, furnace black, thermal black, channel black and ketjen black; and examples of the pigment or dye include Fast Yellow G, Benzidine Yellow, Indo Fast Orange, Irgazin Red, Carmine FB, Permanent Bordeaux FRR, Pigment Orange R, Lithol Red 2G, Lake Red C, Rhodamine FB, Rhodamine B Lake, Phthalocyanine Blue, Pigment Blue, Brilliant Green B, Phthalocyanine Green and quinacridone. These materials can be used singly or in admixture. The addition amount of the coloring agent can be, for example, from 4 to 10 parts by weight based on 100 parts by weight of the binder resin.

As the charge controlling agent, for example, a metal-containing azo compound is useful. Complexes or complex salts in which a metal element of the metal-containing azo compound is selected from iron, cobalt and chromium, or mixtures thereof can be used. Also, a metal-containing salicylic acid derivative compound or a metal oxide hydrophobilized material is useful. Complexes or complex salts in which a metal element thereof is selected from zirconium, zinc and chromium, or mixtures thereof; and complexes or complex salts of such a metal and boron, or mixtures thereof are desirable. A clathrate compound of polysaccharide containing aluminum and magnesium can be used. The addition amount of the charge controlling agent can be, for example, from 0.5 to 2 parts by weight based on the 100 parts by weight of the binder resin.

Examples of an apparatus for mixing and dispersing the toner particle material include a Henschel mixer (manufactured by Mitsui Mining Company, Limited.); a super mixer (manufactured by Kawata Mfg., Co., Ltd.); Ribocone (manufactured by Okawara Mfg., Co., Ltd.); a nauta mixer, a turbulizer and a cyclomixer (all of which are manufactured by Hosokawa Micron Corporation); a spiral pin mixer (manufactured by Pacific Machinery & Engineering Co., Ltd.); and a Lodige mixer (manufactured by Matsubo Corporation). Examples of a kneader include a KRC kneader (manufactured by Kurimoto, Ltd.); a Buss Ko-kneader (manufactured by Buss); a TEM type extruder (manufactured by Toshiba Machine Co., Ltd.); a TEX two-screw kneader (manufactured by The Japan Steel Works, Ltd.); a PCM kneader (manufactured by Ikegai, Ltd.); a three-roll mill, a mixing roll mill and a kneader (all of which are manufactured by Inoue Mfg., Inc.); Kneadex (manufactured by Mitsui Mining Company, Limited.); an MS type pressure kneader, a kneader-ruder (manufactured by Moriyama Company Ltd.); and a Banbury mixer (manufactured by manufactured by Kobe Steel, Ltd.).

Also, as an apparatus for coarsely pulverizing the mixture, for example, a hammer mill, a cutter mill, a jet mill, a roller mill, a ball mill, etc. can be used. Also, examples of an apparatus for finely pulverizing the coarsely pulverized material include a counterjet mill, Micronjet and Inomizer (all of which are manufactured by Hosokawa Micron Corporation); an IDS type mill and a PJM jet pulverizer (all of which are manufactured by Nippon Pneumatic Mfg. Co., Ltd.); Crossjet Mill (manufactured by Kurimoto, Ltd.); Ulmax (manufactured by Nisso Engineering Co., Ltd.); SK Jet-O-Mill (manufactured by Seisin Enterprise Co., Ltd.); Cliptron (manufactured by Kawasaki Heavy Industries, Ltd.); and Turbo Mill (manufactured by Turbo Kogyo Co., Ltd.).

Also, examples of a classifier for classifying the finely pulverized material include Classiel, Micron Classifier and Spedic Classifier (all of which are manufactured by Seisin Enterprises Co., Ltd.); Turbo Classifier (manufactured by Nisshin Engineering Co., Ltd.); Micron separator, Turboplex (ATP) and TSP Separator (all of which are manufactured by Hosokawa Micron Corporation); Elbow-Jet (manufactured by Nittetsu Mining Co., Ltd.); Dispersion Separator (manufactured by Nippon Pneumatic Mfg. Co., Ltd.); and YM Microcut (manufactured by Yasukawa Shoji K.K.).

In the embodiment, in order to stabilize fluidity, charge properties or storage properties of the toner, a fine particle additive can be mixed on the toner particle surface. As such a fine particle additive, a mixture of at least two kinds of inorganic fine particle oxides having a different volume average particle size from each other, which are selected from silica, titania, alumina, strontium titanate and tin oxide, can be used. From the viewpoint of enhancing the environmental stability, a material obtained by a surface treatment with a hydrophobic agent can be used as such an inorganic fine particle oxide. Also, in addition to such an inorganic fine particle oxide, a resin fine particle of not larger than 1 μm can be added.

As an apparatus for mixing the additives, the foregoing mixing machine is useful.

Examples of a screening apparatus for sieving coarse particles or the like include Ultra Sonic (manufactured by Koei Sangyo Co., Ltd.); Resona Sieve and Gyroshifter (all of which are manufactured by Tokuju Corporation); Vibrasonic System (manufactured by Dalton Co., Ltd.); Soniclean (manufactured by Shinto Kogyo Kabushiki Kaisha); Turboscreener (manufactured by Turbo Kogyo Co., Ltd.); Microshifter (manufactured by Makino Mfg. Co., Ltd.); and a circular vibrating separator.

The embodiments are hereunder described in more detail by reference to the accompanying drawings.

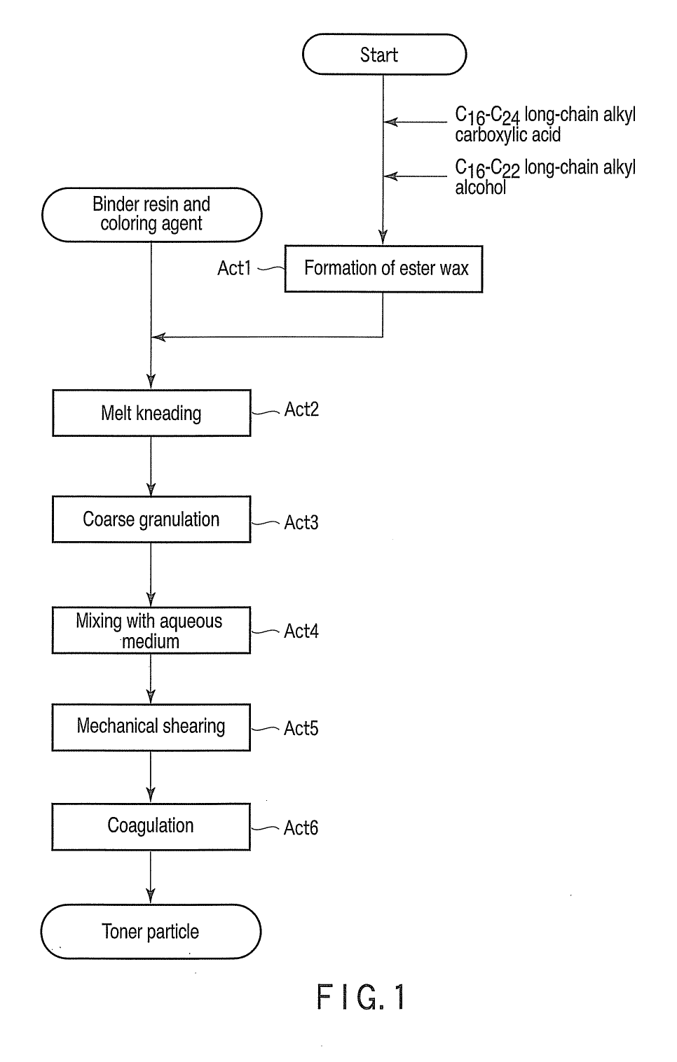

A flow expressing an example of a manufacturing method of the developing agent according to the embodiment is shown in FIG. 1.

As shown in FIG. 1, first of all, esterification is carried out using a long-chain alkyl carboxylic acid component having a carbon number of from 16 to 24 and a long-chain alkyl alcohol component having a carbon number of from 16 to 22, to form an ester wax (Act 1).

Subsequently, a binder resin, a coloring agent and the ester wax are mixed to prepare a toner particle material, and the obtained toner particle material is melt kneaded to form a kneaded material (Act 2).

Subsequently, the kneaded material is pulverized to form a coarsely granulated mixture (Act 3).

Thereafter, the coarsely granulated mixture is mixed with an aqueous medium to prepare a dispersion (Act 4).

The obtained dispersion is subjected to mechanical shearing, to form a fine particle of the coarsely granulated mixture (Act 5).

The fine particle is coagulated in the dispersion, to form a coagulated particle (Act 6).

The obtained coagulated particle is fused, if desired, whereby a toner particle can be formed.

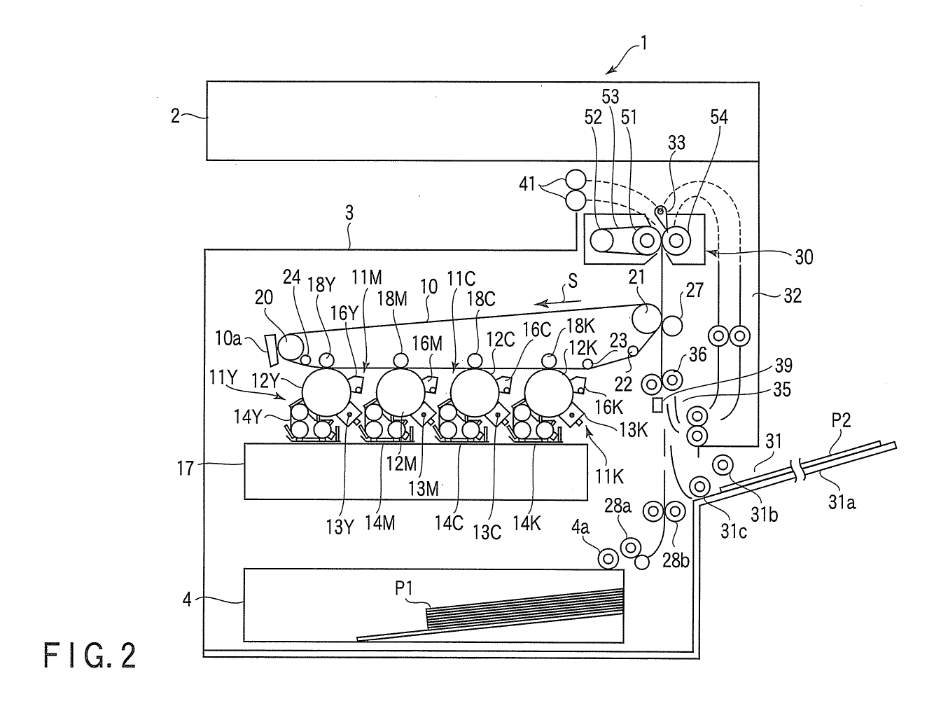

A diagrammatic view showing an example of an image forming apparatus to which the developing agent according to the embodiment is applicable is shown in FIG. 2.

As shown in FIG. 2, a scanner section 2 and a paper discharge section 3 are provided in an upper portion of a color copier, MFP (e-studio 4520c) 1 of a quadruple tandem system.

The color copier 1 has image forming stations 11Y, 11M, 11C and 11K of four groups of yellow (Y), magenta (M), cyan (C) and black (K) disposed in parallel along a lower side of an intermediate transfer belt (intermediate transfer medium) 10.

The respective image forming stations 11Y, 11M, 11C and 11K have photoreceptor drums (image carriers) 12Y, 12M, 12C and 12K, respectively. In the surroundings of the photoreceptor drums 12Y, 12M, 12C and 12K, electrification chargers 13Y, 13M, 13C and 13K; development apparatuses 14Y, 14M, 14C and 14K; and photoreceptor cleaning apparatuses 16Y, 16M, 16C and 16K are disposed along the rotation direction shown by an arrow S direction. On the way from the electrification chargers 13Y, 13M, 13C and 13K to the development apparatuses 14Y, 14M, 14C and 14K in the surroundings of the photoreceptor drums 12Y, 12M, 12C and 12K, laser light is applied by a laser exposure apparatus (latent image forming apparatus) 17, an electrostatic latent image is formed on the photoreceptor drums 12Y, 12M, 12C and 12K.

Each of the development apparatuses 14Y, 14M, 14C and 14K has a two-component developing agent composed of each of yellow (Y), magenta (M), cyan (C) and black (K) toners and a carrier, respectively and feeds the toner to the electrostatic latent image on the photoreceptor drums 12Y, 12M, 12C and 12K, respectively.

The intermediate transfer belt 10 is hung by a backup roller 21, a driven roller 20 and first to third tension rollers 22 to 24. The intermediate transfer belt 10 is opposed to and brought into contact with the photoreceptor drums 12Y, 12M, 12C and 12K. Primary transfer rollers 18Y, 18M, 18C and 18K for primarily transferring the toner images on the photoreceptor drums 12Y, 12M, 12C and 12K onto the intermediate transfer belt 10 are provided at positions of the intermediate transfer belt 10 opposing the photoreceptor drums 12Y, 12M, 12C and 12K, respectively. Each of these primary transfer rollers 18Y, 18M, 18C and 18K is a conductive roller, and a primary transfer bias voltage is impressed in each of these primary transfer sections.

A secondary roller 27 is disposed in a secondary transfer section which is a transfer position of the intermediate transfer belt 10 supported by the backup roller 21. In the secondary transfer section, the backup roller 21 is a conductive roller, and a prescribed secondary transfer bias is impressed thereto. When a sheet paper (final transfer medium) which is an object to printing passes between the intermediate transfer belt 10 and the secondary transfer roller 27, the toner image on the intermediate transfer belt 10 is secondarily transferred onto the sheet paper. After completion of the secondary transfer, the intermediate transfer belt 10 is cleaned up by a belt cleaner 10a.

A paper feed cassette 4 for feeding a sheet paper P1 toward the direction of the secondary transfer roller 27 is provided in a lower portion of the laser exposure apparatus 17. A manual-bypass mechanism 31 for manually feeding a sheet paper P2 is provided on the right side of the color copier 1.

On the way from the paper feed cassette 4 to the secondary transfer roller 27, a pickup roller 4a, a separation roller 28a, a carrying roller 28b and a resist roller pair 36 are provided, thereby constituting a paper feed mechanism. On the way from a manual-bypass tray 31a of the manual-bypass mechanism 31 to the resist roller pair 36, a manual-bypass pickup roller 31b and a manual-bypass separation roller 31c are provided.

Furthermore, a medium sensor 39 for detecting the kind of sheet paper is disposed on a vertical carrying route 35 for carrying the sheet paper from the paper feed cassette 4 or the manual-bypass tray 31a toward the direction of the secondary transfer roller 27. The color copier 1 is able to control a carrying rate of sheet paper, a transfer condition, a fixing condition and so on from the detection results by the medium sensor 39. Also, a fuser units 30 is provided in the downstream of the secondary transfer section along the direction of the vertical carrying route 35.

The sheet paper taken out from the paper feed cassette 4 or fed from the manual-bypass mechanism 31 is carried into the fuser units 30 through the resist roller pair 36 and the secondary transfer roller 27 along the vertical carrying route 35. The fuser units 30 has a fuser units 53 wound around a pair of a heating roller 51 and a driving roller 52 and a counter roller 54 disposed opposing the heating roller 51 via the fuser units 53. The sheet paper having a toner image transferred in the secondary transfer section is introduced between the fuser units 53 and the counter roller 54, and the toner image transferred onto the sheet paper is heat treated and fixed upon heating by the heating roller 51. A gate 33 is provided in the downstream of the fuser units 30, whereby the sheet paper is distributed into the direction of a paper discharge roller 41 and the direction of a recarrying unit 32. The sheet paper introduced into the paper discharge roller 41 is discharged into the paper discharge section 3. Also, the sheet paper introduced into the recarrying unit 32 is again introduced onto the direction of the secondary transfer roller 27.

The image forming station 11Y has the photoreceptor drum 12Y and a process measure in an integral manner and is provided in a detachable manner relative to a main body of the image forming apparatus. The process measure as referred to herein means at least one of the electrification charger 13Y, the development apparatus 14Y and the photoreceptor cleaning apparatus 16Y. Each of the image forming stations 11M, 11C and 11K has the same configuration as the image forming station 11Y. Each of the image forming stations 11Y, 11M, 11C and 11K may be detachable relative to the image forming apparatus or may be detachable as the integrated image forming unit 11 relative to the image forming apparatus.

Examples are hereunder shown, and the embodiments are more specifically described.

### EXAMPLES

### Preparation Example of Ester Wax

In a four-necked flask equipped with a stirrer, a thermocouple and a nitrogen introducing pipe, 80 parts by weight of a long-chain alkyl carboxylic acid component and 20 parts by weight of a long-chain alkyl alcohol component were charged and subjected to an esterification reaction at 220° C. in a nitrogen gas stream. The obtained reaction product was diluted with a mixed solvent of toluene and ethanol, to which was then added a sodium hydroxide aqueous solution, and the mixture was stirred at 70° C. for 30 minutes. Thereafter, the reaction mixture was allowed to stand for 30 minutes, thereby removing an aqueous layer part. Furthermore, an operation of adding ion exchanged water, stirring the mixture at 70° C. for 30 minutes and then allowing the reaction mixture to stand for 30 minutes, thereby removing an aqueous layer part was repeated five times. The solvent was distilled off from the obtained ester layer under a reduced pressure condition, thereby obtaining Ester Wax (A) having an acid value of 0.1 mgKOH/g and a hydroxyl value of 0.5 mgKOH/g. A structural formula showing an example of the ester wax is expressed by the following formula (1).

CH₃(CH₂)ₙCOO(CH₂)ₘCH₃ (1)

In the formula (1), each of n and m represents a constant.

Respective ester waxes were prepared by changing the kind and amount of the long-chain alkyl carboxylic acid and the kind and amount of the long-chain alkyl alcohol. In particular, in the case of broadening the distribution, the preparation was carried out by using plural kinds in both of the long-chain alkyl carboxylic acid component and the long-chain alkyl alcohol component.

Data of the respective ester waxes are shown in Table 1.

TABLE 1

| | | | | | | | | | | Melting | | Hydroxyl |
|---|---|---|---|---|---|---|---|---|---|---|---|---|
| | Proportion of ester wax compound (%) | | | | | | | | | point | Acid value | value |
| Wax | C32 | C34 | C36 | C38 | C40 | C42 | C44 | C46 | C48 | (° C.) | (mgKOH/g) | (mgKOH/g) |
| A | 0 | 0 | 5.3 | 5.8 | 13.8 | 27 | 40 | 2.7 | 5.4 | 73 | 0.1 | 0.5 |
| B | 0 | 0 | 2.5 | 6.2 | 8.4 | 30.9 | 45 | 32 | 3.8 | 74 | 0.1 | 0.4 |
| C | 0 | 0 | 6 | 10.6 | 14.7 | 22.8 | 22 | 17.1 | 6.8 | 67 | 0.1 | 0.5 |

### Long-Chain Alkyl Carboxylic Acid Component

Palmitic acid (C₁₆H₃₂O₂)

Stearic acid (C₁₈H₃₆O₂)

Arachidic acid (C₂₀H₄₀O₂)

Behenic acid (C₂₂H₄₄O₂)

Lignoceric acid (C₂₄H₄₈O₂)

### Long-Chain Alkyl Alcohol Component

Palmityl alcohol (C₁₆H₃₄O)

Stearyl alcohol (C₁₈H₃₈O)

Arachidic alcohol (C₂₀H₄₂O)

Behenyl alcohol (C₂₂H₄₆O)

Also, the melting point of the obtained ester wax is measured by using DSC (DSC Q2000, manufactured by TA Instruments). The measurement is carried out under the following condition.

Sample: 5 mg

Lid and pan: Alumina

Temperature elevation rate: 10° C./min

Measurement temperature: 20 to 200° C.

A data obtained by the measurement in which the sample heated to 200° C. is cooled to 20° C. or lower and again heated is employed, and a maximum endothermic peak generated at 60° C., et seq. is defined as a melting point of the wax.

A mass analysis of the obtained ester wax is measured by using FD/MS (JMS-T100GC, manufactured by JEOL Ltd.). The measurement is carried out under the following condition.

Sample: 1 mg (dissolved in 1 mL of chloroform)

Cathode voltage: −10 kV

Spectrum recording interval: 0.4 seconds

Measuring mass range: m/z 10 to 2,000

A maximum strength in the total carbon number of the acid components and alcohol components of from C32 to C46 was confirmed, and a strength of 5% or more from the maximum strength was employed as a data. All of the strengths employed as the data were gathered to 100, and a relative strength of each carbon number was calculated. As to Ester Wax (G) using rice wax, C54 was defined as the maximum strength, and a strength of 5% or more from the maximum strength was employed as a data.

The acid value and hydroxyl value of the obtained ester wax were measured according to JIS K0070.

### Preparation of Comparative Ester Wax (D)

The blending amounts of behenic acid and behenyl alcohol were increased, and Comparative Ester Wax (D) in which the weight % of the carbon number as a maximum frequency among the carbon numbers of from C32 to C46 was 50% by weight or more of the whole of the wax was prepared. A data of Comparative Ester Wax (D) is shown in Table 2.

### Preparation of Comparative Ester Wax (E)

Comparative Ester Wax (E) was prepared by using only behenic acid as the acid component and behenyl alcohol as the alcohol component. A data of Comparative Ester Wax (E) is shown in Table 2.

### Preparation of Comparative Ester Wax (F)

Comparative Ester Wax (F) was prepared by using only palmitic acid as the acid component and palmityl alcohol as the alcohol component. A data of Comparative Ester Wax (F) is shown in Table 2.

### Comparative Ester Wax (G)

Rice wax is used. A data is shown in Table 3.

TABLE 2

| | | | | | | | | | | Melting | | Hydroxyl |
|---|---|---|---|---|---|---|---|---|---|---|---|---|
| | Proportion of ester wax compound (%) | | | | | | | | | point | Acid value | value |
| Wax | C32 | C34 | C36 | C38 | C40 | C42 | C44 | C46 | C48 | (° C.) | (mgKOH/g) | (mgKOH/g) |
| D | 0 | 0 | 0 | 0.5 | 6.2 | 16.4 | 73 | 1 | 2.9 | 75 | 0.1 | 0.5 |
| E | 0 | 0 | 0 | 0 | 0 | 0 | 100 | 0 | 0 | 77 | 0.1 | 0.3 |
| F | 100 | 0 | 0 | 0 | 0 | 0 | 0 | 0 | 0 | 60 | 0.1 | 0.4 |

TABLE 3

| | | | | | | | | | | Melting | | Hydroxyl |
|---|---|---|---|---|---|---|---|---|---|---|---|---|
| | Proportion of ester wax compound (% by weight) | | | | | | | | | point | Acid value | value |
| Wax | C46 | C48 | C50 | C52 | C54 | C56 | C58 | C60 | C62 | (° C.) | (mgKOH/g) | (mgKOH/g) |
| G | 7 | 12 | 13 | 18 | 20 | 15 | 10 | 5 | 0 | 79 | 6.3 | 15.4 |

### Evaluation of Fixing Offset

In a fixing system modification of commercially available e-studio 6530c (manufactured by Toshiba Tec Corporation), the fixing temperature is set up at 140° C., and 10 sheets of a solid image are obtained. In those ten sheets, the case where the image separation by offset or unfixing was not generated even slightly is defined as “Good”; and the case where the separation was generated is defined as “Bad”.

### Life Extension and Toner Dusting

Using commercially available e-studio 6530c (manufactured by Toshiba Tec Corporation), an original with a printing ratio of 8.0% was continuously copied on 300,000 sheets of A4. At that time, the case where staining such as falling of toner, etc. to be caused due to the toner dusting was not confirmed is defined as “Good”; and the case where staining was confirmed is defined as “Bad”.

### Storage Characteristic

15 g of a toner is hermetically sealed in a plastic vessel and allowed to stand in a thermostat set up at 55° C. for 10 hours. After taking out from the thermostat, the toner was allowed to stand for naturally cooling for 12 hours or more. By using a powder tester (manufactured by Hosokawa Micron Corporation), the resulting toner was placed on a screen having an opening of 42 mesh and vibrated for 10 seconds at a dial of 4. The case where the amount of the toner remaining on the screen after the vibration was from 0 or more and less than 3 g is defined as “Good”; and the case where it was 3 g is defined as “Bad”.

### Example 1

Polyester resin: 90 parts by weight

Ester Wax (A): 3 parts by weight

Coloring agent (MA-100): 6 parts by weight

Charge controlling agent (polysaccharide containing Al and Mg): 1 part by weight

The foregoing materials were mixed in a Henschel mixer, and the mixture was melt kneaded by a twin-screw extruder. The obtained melt kneaded material was cooled and then coarsely pulverized by a hammer mill. Subsequently, the coarsely pulverized material was finely pulverized by a jet pulverizer and classified, thereby obtaining a powder having a volume average particle size of 7 μm and a toner Tg of 55.8° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner.

The obtained toner was stirred in a proportion of 6 parts by weight based on 100 parts by weight of a silicone resin-surface coated ferrite carrier having an average particle size of 40 μm in a tabular mixer, thereby obtaining a developing agent. The obtained toner and developing agent were set in a modified machine of a full color copier, e-studio 6530c (manufactured by Toshiba Tec Corporation), the fixing temperature was set up at 140° C., and 10 sheets of a solid image with a toner deposition amount of 1.6 mg/cm² were allowed to pass therethrough, thereby confirming whether or not offset was generated. As a result, it could be confirmed that no offset was generated. Furthermore, the foregoing material quality characteristics of life extension and storage characteristic were confirmed. The evaluation results are summarized in Table 4. The toner Tg was determined by using the following apparatus and measurement condition.

0.5 g of the obtained toner was weighed and charged in an Erlenmeyer flask. In the Erlenmeyer flask, 2 mL of methylene chloride was added, thereby dissolving the toner therein. Furthermore, 4 mL of hexane was added, an insoluble matter was filtered off, and the solvent was distilled off in a nitrogen gas stream, thereby obtaining a deposit. This deposit was dissolved in 1 mL of chloroform and subjected to FD/MS measurement. The measurement results are summarized in the following Table 5.

### Toner Tg

The toner Tg is measured by using DSC (DSC Q2000, manufactured by TA Instruments). The measurement is carried out under the following condition.

Sample: 5 mg

Lid and pan: Alumina

Temperature elevation rate: 10° C./min

Measurement temperature: 20 to 200° C.

A data obtained by the measurement in which the sample heated to 200° C. is cooled to 20° C. or lower and again heated is employed. Tangents on the low temperature side and the high temperature side of a curve generated in the vicinity of from 40 to 70° C. are drawn, and a point of intersection of extension lines thereof is defined as Tg.

### Example 2

Polyester resin: 87.5 parts by weight

Ester Wax (A): 6 parts by weight

Coloring agent (MA-100): 6 parts by weight

Charge controlling agent (polysaccharide containing Al and Mg): 0.5 parts by weight

The foregoing materials were treated in the same manner as in Example 1, thereby obtaining a powder having a volume average particle size of 7 μm and a toner Tg of 54.3° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in the following Table 5.

### Example 3

Polyester resin: 82 parts by weight

Ester Wax (A): 10 parts by weight

Coloring agent (MA-100): 6 parts by weight

Charge controlling agent (polysaccharide containing Al and Mg): 2 parts by weight

The foregoing materials were treated in the same manner as in Example 1, thereby obtaining a powder having a volume average particle size of 7 μm and a toner Tg of 53.7° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Example 4

Polyester resin: 87 parts by weight

Ester Wax (B): 6 parts by weight

Coloring agent (MA-100): 6 parts by weight

Charge controlling agent (polysaccharide containing Al and Mg): 1 part by weight

The foregoing materials were treated in the same manner as in Example 1, thereby obtaining a powder having a volume average particle size of 7 μm and a toner Tg of 54.2° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Example 5

Polyester resin: 83.5 parts by weight

Ester Wax (B): 10 parts by weight

Coloring agent (MA-100): 6 parts by weight

Charge controlling agent (polysaccharide containing Al and Mg): 0.5 parts by weight

The foregoing materials were treated in the same manner as in Example 1, thereby obtaining a powder having a volume average particle size of 7 μm and a toner Tg of 53.8° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Example 6

Polyester resin: 89 parts by weight

Ester Wax (B): 3 parts by weight

Coloring agent (MA-100): 6 parts by weight

Charge controlling agent (polysaccharide containing Al and Mg): 2 parts by weight

The foregoing materials were treated in the same manner as in Example 1, thereby obtaining a powder having a volume average particle size of 7 μm and a toner Tg of 55.5° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Example 7

Polyester resin: 83 parts by weight

Ester Wax (C): 10 parts by weight

Coloring agent (MA-100): 6 parts by weight

Charge controlling agent (polysaccharide containing Al and Mg): 1 part by weight

The foregoing materials were treated in the same manner as in Example 1, thereby obtaining a powder having a volume average particle size of 7 μm and a toner Tg of 53.7° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Example 8

Polyester resin: 90.5 parts by weight

Ester Wax (C): 3 parts by weight

Coloring agent (MA-100): 6 parts by weight

Charge controlling agent (polysaccharide containing Al and Mg): 0.5 parts by weight

The foregoing materials were treated in the same manner as in Example 1, thereby obtaining a powder having a volume average particle size of 7 μm and a toner Tg of 55.3° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Example 9

Polyester resin: 86 parts by weight

Ester Wax (C): 6 parts by weight

Coloring agent (MA-100): 6 parts by weight

Charge controlling agent (polysaccharide containing Al and Mg): 2 parts by weight

The foregoing materials were treated in the same manner as in Example 1, thereby obtaining a powder having a volume average particle size of 7 μm and a toner Tg of 54.6° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Example 10

Polyester resin: 90 parts by weight

Ester Wax (C): 6 parts by weight

Coloring agent (MA-100): 6 parts by weight

Charge controlling agent (polysaccharide containing Al and Mg): 1 part by weight

The foregoing materials were mixed in a Henschel mixer, and the mixture was melt kneaded by a twin-screw extruder. The obtained melt kneaded material was cooled and coarsely pulverized by a hammer mill. Subsequently, the coarsely pulverized material was further pulverized using a pulverizer, manufactured by Hosokawa Micron Corporation, thereby obtaining an interim pulverized particle having a volume average particle size of 58 μm. 30 parts by weight of the obtained interim pulverized particle, 1 part by weight of sodium dodecylbenzenesulfonate (NEOPELEX G-15) as an anionic surfactant, 1 part by weight of triethylamine as an amine compound and 68 parts by weight of ion exchanged water were mixed by a homogenizer, manufactured by IKA, thereby obtaining Mixed Solution 1.

Subsequently, the obtained Mixed Solution 1 was charged in NANO-MIZER (YSNM-2000AR, manufactured by Yoshida Kikai Co., Ltd., to which a heating system was add) in which the heating system temperature was set up at 120° C., and treated repeatedly three times under a treatment pressure of 150 MPa. After cooling, a volume average particle size of the obtained colored fine particle was measured by SALD-7000 (manufactured by Shimadzu Corporation). As a result, it was found to be 0.7 μm. A pH of the fine particle dispersion was 8.2.

Subsequently, the dispersion was diluted such that a solid content of the colored fine particle was 18%, to which was then added dropwise 0.1 M hydrochloric acid, thereby adjusting the pH. The dispersion was controlled to a temperature of 30° C. At a point of time when the pH reached 7.0, the particle size was measured. As a result, it was found to be 0.85 μm. Furthermore, 0.1 M hydrochloric acid was added dropwise, and at a point of time when a ξ potential of the fine particle reached −30 mV, the dropwise addition was finished. At that time, the pH was 3.9.

Subsequently, the dispersion was subjected to temperature elevation to 80° C. at a rate of 10° C./min while stirring with a paddle blade (at 500 rpm) and then kept at 80° C. for one hour. After cooling, the dispersion was allowed to stand overnight, and the state of a supernatant was observed. As a result, the supernatant was transparent, and any uncoagulated particle was not observed. Also, the volume average particle size was measured. As a result, it was found to be 6 μm, and any coarse particle of 20 μm was not observed. Thereafter, the resultant was dried by a vacuum dryer until the water content reached not more than 0.8% by weight, thereby obtaining a powder having a volume average particle size of 6 μm and a toner Tg of 54.5° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 1

Polyester resin: 86 parts by weight

Ester Wax (D): 6 parts by weight

Coloring agent (MA-100): 6 parts by weight

Charge controlling agent (polysaccharide containing Al and Mg): 2 parts by weight

The foregoing materials were treated in the same manner as in Example 1, thereby obtaining a powder having a volume average particle size of 7 μm and a toner Tg of 55.5° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 2

Polyester resin: 82 parts by weight

Ester Wax (D): 10 parts by weight

Coloring agent (MA-100): 6 parts by weight

Charge controlling agent (metal-containing salicylic acid derivative): 2 parts by weight

The foregoing materials were treated in the same manner as in Example 1, thereby obtaining a powder having a volume average particle size of 7 μm and a toner Tg of 53.9° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 3

Polyester resin: 76 parts by weight

Ester Wax (E): 15 parts by weight

Coloring agent (MA-100): 6 parts by weight

Charge controlling agent (polysaccharide containing Al and Mg): 3 parts by weight

The foregoing materials were treated in the same manner as in Example 1, thereby obtaining a powder having a volume average particle size of 7 μm and a toner Tg of 52.1° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 4

Polyester resin: 86.5 parts by weight

Ester Wax (E): 6 parts by weight

Coloring agent (MA-100): 6 parts by weight

Charge controlling agent (metal-containing salicylic acid derivative): 1.5 parts by weight

The foregoing materials were treated in the same manner as in Example 1, thereby obtaining a powder having a volume average particle size of 7 μm and a toner Tg of 56.8° C. To 100 parts by weight of this powder, 1 part by weight of a monodispersed inorganic fine particle compound having an average primary particle size of 100 nm, 1 part by weight of hydrophobic silica having an average primary, particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 5

Polyester resin: 86.5 parts by weight

Ester Wax (D): 6 parts by weight

Coloring agent (MA-100): 6 parts by weight

Charge controlling agent (polysaccharide containing Al and Mg): 1.5 parts by weight

The foregoing materials were treated in the same manner as in Example 1, thereby obtaining a powder having a volume average particle size of 7 μm and a toner Tg of 55.4° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 6

Polyester resin: 90 parts by weight

Ester Wax (A): 2 parts by weight

Coloring agent (MA-100): 6 parts by weight

Charge controlling agent (metal-containing azo compound): 2 parts by weight

The foregoing materials were treated in the same manner as in Example 1, thereby obtaining a powder having a volume average particle size of 7 μm and a toner Tg of 57.3° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 7

Polyester resin: 77 parts by weight

Ester Wax (B): 15 parts by weight

Coloring agent (MA-100): 6 parts by weight

Charge controlling agent (metal-containing azo compound+polysaccharide containing Al and Mg): 2 parts by weight

The foregoing materials were treated in the same manner as in Example 1, thereby obtaining a powder having a volume average particle size of 7 μm and a toner Tg of 51.7° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 8

Polyester resin: 77 parts by weight

Ester Wax (C): 15 parts by weight

Coloring agent (MA-100): 6 parts by weight

Charge controlling agent (metal-containing salicylic acid derivative+polysaccharide containing Al and Mg): 2 parts by weight

The foregoing materials were treated in the same manner as in Example 1, thereby obtaining a powder having a volume average particle size of 7 μm and a toner Tg of 51.4° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 9

Polyester resin: 86 parts by weight

Ester Wax (F): 6 parts by weight

Coloring agent (MA-100): 6 parts by weight

Charge controlling agent (polysaccharide containing Al and Mg): 2 parts by weight

The foregoing materials were treated in the same manner as in Example 1, thereby obtaining a powder having a volume average particle size of 7 μm and a toner Tg of 49.8° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 10

Polyester resin: 86 parts by weight

Ester Wax (G): 6 parts by weight

Coloring agent (MA-100): 6 parts by weight

Charge controlling agent (polysaccharide containing Al and Mg): 2 parts by weight

The foregoing materials were treated in the same manner as in Example 1, thereby obtaining a powder, having a volume average particle size of 7 μm and a toner Tg of 57.1° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

### Comparative Example 11

Polyester resin: 86 parts by weight

Ester Wax (G): 6 parts by weight

Coloring agent (MA-100): 6 parts by weight

Charge controlling agent (polysaccharide containing Al and Mg): 2 parts by weight

The foregoing materials were treated in the same manner as in Example 1, thereby obtaining a powder having a volume average particle size of 7 μm and a toner Tg of 53.1° C. To 100 parts by weight of this powder, 1 part by weight of a monodispersed inorganic fine particle compound having an average primary particle size of 100 nm, 1 part by weight of hydrophobic silica having an average primary particle size of 30 nm and 0.5 parts by weight of a hydrophobic titanium oxide having an average primary particle size of 20 nm were added and mixed in a Henschel mixer, thereby manufacturing a toner. Furthermore, a developing agent was prepared in the same manner as in Example 1 and evaluated in the same manner as in Example 1. The evaluation results are shown in Table 4. Also, the wax was extracted from the toner. The measurement results are shown in Table 5.

TABLE 4

| | | Amount | Lower | | | |
|---|---|---|---|---|---|---|
| | | of wax | temperature | Life extension | Storage | |
| | Wax | (%) | fusing | (toner dusting) | characteristic | Toner Tg |
| Example 1 | A | 3 | Good | Good | Good | 55.8 |
| Example 2 | A | 6 | Good | Good | Good | 54.3 |
| Example 3 | A | 10 | Good | Good | Good | 53.7 |
| Example 4 | B | 6 | Good | Good | Good | 54.2 |
| Example 5 | B | 10 | Good | Good | Good | 53.8 |
| Example 6 | B | 3 | Good | Good | Good | 55.5 |
| Example 7 | C | 10 | Good | Good | Good | 53.7 |
| Example 8 | C | 3 | Good | Good | Good | 55.3 |
| Example 9 | C | 6 | Good | Good | Good | 54.6 |
| Example 10 | C | 6 | Good | Good | Good | 54.5 |
| Comparative | D | 6 | Bad | Good | Good | 55.5 |
| Example 1 | | | | | | |
| Comparative | D | 10 | Good | Bad | Bad | 53.9 |
| Example 2 | | | | | | |
| Comparative | E | 15 | Good | Bad | Bad | 52.1 |
| Example 3 | | | | | | |
| Comparative | E | 6 | Bad | Good | Good | 56.8 |
| Example 4 | | | | | | |
| Comparative | D | 6 | Bad | Good | Good | 55.4 |
| Example 5 | | | | | | |
| Comparative | A | 2 | Bad | Good | Good | 57.3 |
| Example 6 | | | | | | |
| Comparative | B | 15 | Good | Bad | Bad | 51.7 |
| Example 7 | | | | | | |
| Comparative | C | 15 | Good | Bad | Bad | 51.4 |
| Example 8 | | | | | | |
| Comparative | F | 6 | Good | Good | Bad | 49.8 |
| Example 9 | | | | | | |
| Comparative | G | 6 | Bad | Good | Good | 57.1 |
| Example 10 | | | | | | |
| Comparative | G | 6 | Good | Good | Bad | 53.1 |
| Example 11 | | | | | | |

TABLE 5

| | | Content proportion of ester wax compound (% by weight) | | | | | | | | |
|---|---|---|---|---|---|---|---|---|---|---|
| | Wax | C32 | C34 | C36 | C38 | C40 | C42 | C44 | C46 | Others |
| Example 1 | A | 0 | 0 | 5.5 | 5.7 | 13.9 | 28.4 | 39.5 | 1.9 | 5.1 |
| Example 2 | A | 0 | 0 | 5.4 | 5.6 | 14.1 | 28.2 | 39.3 | 2.2 | 5.2 |
| Example 3 | A | 0 | 0 | 5.6 | 5.4 | 13.8 | 27.4 | 41.3 | 1.8 | 4.7 |
| Example 4 | B | 0 | 0 | 2.4 | 6.1 | 8.9 | 32.2 | 44.6 | 2.4 | 3.4 |
| Example 5 | B | 0 | 0 | 2.5 | 6 | 8.6 | 32.9 | 44.2 | 2.6 | 3.2 |
| Example 6 | B | 0 | 0 | 2.6 | 6.3 | 9.2 | 32.1 | 44.3 | 2.4 | 3.1 |
| Example 7 | C | 0 | 0 | 5.8 | 10.8 | 16.9 | 23.8 | 20.9 | 16.4 | 5.4 |
| Example 8 | C | 0 | 0 | 5.9 | 10.4 | 15.9 | 24.5 | 22.6 | 15.8 | 4.9 |
| Example 9 | C | 0 | 0 | 6.1 | 10.9 | 16.7 | 23.5 | 22.4 | 15.6 | 4.8 |
| Example 10 | C | 0 | 0 | 6.2 | 10.5 | 15.4 | 23.4 | 21.4 | 16.3 | 6.8 |
| Comparative | D | 0 | 0 | 0 | 0.6 | 6.3 | 15.9 | 74 | 0.8 | 2.4 |
| Example 1 | | | | | | | | | | |
| Comparative | D | 0 | 0 | 0 | 0.4 | 6.5 | 16.2 | 73.6 | 0.7 | 2.6 |
| Example 2 | | | | | | | | | | |
| Comparative | E | 0 | 0 | 0 | 0 | 0 | 0 | 100 | 0 | 0 |
| Example 3 | | | | | | | | | | |
| Comparative | E | 0 | 0 | 0 | 0 | 0 | 0 | 100 | 0 | 0 |
| Example 4 | | | | | | | | | | |
| Comparative | D | 0 | 0 | 0 | 1 | 5.9 | 16 | 73.9 | 0.8 | 2.4 |
| Example 5 | | | | | | | | | | |
| Comparative | A | 0 | 0 | 5.6 | 5.9 | 14.2 | 26.4 | 40.6 | 2.5 | 4.8 |
| Example 6 | | | | | | | | | | |
| Comparative | B | 0 | 0 | 2.6 | 6.5 | 9 | 29.5 | 45.9 | 3 | 3.5 |
| Example 7 | | | | | | | | | | |
| Comparative | C | 0 | 0 | 6.5 | 11.1 | 15.1 | 23.8 | 20.2 | 16.4 | 6.9 |
| Example 8 | | | | | | | | | | |
| Comparative | F | 100 | 0 | 0 | 0 | 0 | 0 | 0 | 0 | 0 |
| Example 9 | | | | | | | | | | |
| | | Content proportion of ester wax compound (% by weight) | | | | | | | | |
| | Wax | C46 | C48 | C50 | C52 | C54 | C56 | C58 | C60 | C62 |
| Comparative | G | 6 | 13.9 | 12.5 | 17.6 | 22.5 | 14.1 | 9.4 | 4 | 0 |
| Example 10 | | | | | | | | | | |
| Comparative | G | 5 | 11.9 | 13.5 | 19.5 | 22.1 | 14.5 | 9.5 | 4 | 0 |
| Example 11 | | | | | | | | | | |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developing agent comprising a toner particle containing a coloring agent, a binder resin and an ester wax having an alkyl group having a carbon number of from 32 to 46, wherein when the wax is analyzed by an mass spectrometry, an ester compound having a carbon number showing the maximum strength ratio accounts for from 20 to 45% by mass of the whole mass of the wax.

2. The developing agent according to claim 1, wherein the wax is contained in a proportion of 3 to 10% by weight in the toner particle.

3. The developing agent according to claim 1, further comprising a charge controlling agent selected from the group consisting of metal-containing azo compounds containing at least one first metal selected from iron, cobalt and chromium; metal-containing salicylic acid compound derivative compound containing at least one second metal selected from zirconium, zinc and chromium or the second metal and boron; and metal oxide hydrophobilized materials.

4. The developing agent according to claim 1, wherein the ester wax is obtained by undergoing an esterification reaction using a carboxylic acid component having a carbon number of from 16 to 24 and an alcohol component having a carbon number of from 16 to 22.

5. A method for manufacturing a developing agent comprising
performing an esterification reaction using a carboxylic acid component having a carbon number of from 16 to 24 and an alcohol component having a carbon number of from 16 to 22 to form an ester wax which is an ester wax having an alkyl group having a carbon number of from 32 to 46 and in which when the wax is analyzed by an mass spectrometry, an ester compound having a carbon number showing the maximum strength ratio accounts for from 20 to 45% by mass of the whole of the wax; and
forming a toner particle using a toner particle material containing the ester wax, a binder resin and a coloring agent.

6. The method according to claim 5, further comprising, after the esterification reaction, diluting the obtained compound with a mixed solvent of toluene and ethanol; adding a sodium hydroxide aqueous solution; and then washing with water.

7. The method according to claim 5, further comprising
melt kneading the toner particle material to form a kneaded material;
pulverizing the kneaded material to form a coarsely granulated mixture;
mixing the coarsely granulated mixture with an aqueous medium to prepare a dispersion;
subjecting to the dispersion to mechanical shearing to form a fine particle of the coarsely granulated mixture; and
coagulating the fine particle in the dispersion to form a toner particle.
